(19) United States
(12) Patent Application Publication
(10) Pub. No.: US 2011/0026368 A1
(43) Pub. Date: Feb. 3, 2011

(54) GRAPHIC DISPLAY PROGRAMMABLE WRISTWATCH

(76) Inventor: Gregg F. Relyea, San Diego, CA (US)

Correspondence Address: RICHARD D. CLARKE;LAW OFFICE OF RICHARD D. CLARKE, 3755 AVOCADO BLVD., #1000, LA MESA, CA, 91941-7301, US

(21) Appl. No.: 12/937,426

(22) PCT Filed: Apr. 22, 2008
(86) PCT No.: PCT/US08/61178

§ 371 Date: Oct. 12, 2010

(51) Int. Cl. G04B 47/00; B23P 17/00

(52) U.S. Cl. 368/10; 29/896.3; 29/592.1

(57) ABSTRACT

The present application relates to the preferred and alternate embodiment of the graphic display programmable wristwatch and that will display an array of downloadable static and animated Images on an LCD or LED screen to be used to tell time More particularly, the present application relates to a programmable wristwatch that will serve as a platform for downloadable computer generated graphic images by the means of being placed on a docking station cradle at night to charge the battery along with being able to be connected to a computer The preferred and alternate embodiments of the graphic display programmable wristwatch and would have several distinct and innovative elements an LCD or LED screen, a USB port and a wireless sensor port, a time-keeping unit and a central processing unit.

### FIELD OF THE APPLICATION

The present application relates to a graphic display programmable wristwatch that will display an array of downloadable static and animated images on an LCD or LED screen to be used to tell time. More particularly, the present application relates to a programmable wristwatch that will serve as a platform for downloadable computer-generated graphic images that will be linked to a time-keeping function.

### BACKGROUND

For more than one hundred years, analog wristwatches featuring a single time-keeping function were the standard timepiece. In the late 20th Century, digital wristwatches were introduced that displayed the time in digital numbers. Digital watches featured a limited number of functions, such as an alarm, stopwatch, and backlight.

A wristwatch is a singularly important mechanism because it is worn on the body and it can be an item of fashion, personal identity, and function. Despite its integral role in modern life, the technology in the wristwatch has not kept pace with computer generation and the consumer's desire to be able to interact with electronic devices.

Traditional analog and digital wristwatches are highly limited in their display capabilities. With analog wristwatches, there is generally only a single display. With digital wristwatches, there are a limited numbers of displays according to the number of functions. Users often must purchase several wristwatches to meet their design and display desires.

Up to and including the present, the wristwatch has proven to be too small to handle multiple, complex processing functions and remain comfortable to wear. Programmable wrist devices have been attempted by such companies as IBM and Fossil Watch Company. Both companies, however, have abandoned efforts to convert a wristwatch into a PDA (personal display assistant), due to difficulties with size, processing power, power supply, and memory.

Of all the functional devices in current use today, the wristwatch seems to have missed the computer revolution. A user generally has no control over the display of a wristwatch and, even with digital wristwatches, there is no ability for a user to input information into a wristwatch. Thus, there is no interaction between the user and the wristwatch. The graphic display programmable wristwatch would meet the demand of users to interactively participate in the design and appearance of their timepiece by interfacing through a computer. A graphic display programmable wristwatch would enable a user to link the graphic images to the time-keeping function, thus enabling the user to display time in an infinite number of ways. Therefore, a graphic display programmable wristwatch such as this would offer several advantages over traditional analog and digital wristwatches.

Numerous innovations for the wristwatch have been provided in the prior art that are described as follows. Even though these innovations may be suitable for the specific individual purposes which they address, they differ from the present design as hereinafter contrasted. The following is a summary of those prior art patents most relevant to this application at hand, as well a description outlining the difference between the features of the graphic display programmable wristwatch and the prior art.

U.S. Pat. No. 5,790,477 of Rudolf Hauke describes a portable precision wristwatch. In addition to time-keeping functions, this wristwatch features a GPS receiver with antenna, evaluation electronics, a compass, a destination coordinate memory, an input element and a display element. With the evaluation electronics, the coordinates of the location and the directions to the destination are computed and are made directly viewable as a vector display in the display element. Thus, a very compact precision wristwatch is provided that may be personally carried everywhere and worldwide, and directly displays the direction to any destination, in particular as a pocket watch or wristwatch.

This patent describes a wristwatch that also comprises a GPS receiver with antenna, evaluation electronics, a compass, a destination coordinate memory, an input element and a display element. These devices with a wide variety of components tend to be very expensive, bulky and not an item that will be worn comfortably or regularly. The antennas are generally a problem and are often integrated into the watchband.

U.S. Pat. No. 6,775,206 of Jukka-Matti Karhu tells of a radio communication device. The device is operated by user input means. The user input means comprise a circular ring which surrounds a display. The ring is mounted for rotational movement and by movement of the ring the functions of the communication device are controlled, and information is entered. The communication device is preferably a wristwatch phone or a wrist phone.

This patent describes a radio communication device to be worn on the wrist that will function as a wristwatch. The elements of the communication device along with the antenna increase the size and shape of the device enough to make it uncomfortable to wear on your wrist.

U.S. Pat. No. 6,801,476 of Daniel A. Gilmour discloses a wrist-worn phone that is disclosed which includes a main housing with a front surface and a rear surface, the rear surface including speaker holes, the front surface having a display. The wrist-worn phone further includes a first strap attached to a first end of the main housing, the first strap having an outer end. A second strap may be attached to the second end of the main housing, the second strap having an outer end, the outer end of the first strap for connecting with the outer end of the second strap. The second strap may be made from a shape retaining material for forming a generally elongated C shape such that the rear surface of the main housing is on an interior of the C shape. The wrist-worn phone may include an ear latch for hanging the main housing upon a human ear. A body-worn data storage device may include a plug mounted onto a strap of the device for insertion into a port of a computing device.

This patent describes a wrist-worn phone that does not function as a wristwatch. It has a variety of features, which will make it somewhat bulky to wear including an ear latch for hanging the main housing upon a human ear. Used in this manner the watchband would probably get in the way.

U.S. Pat. No. 7,187,908 of Teruhiko Fujisawa describes a wristwatch device having communication function, information display method, control program, and recording medium. A user can easily identify the content of data (the value or the state of the data), such as a credit balance, stored in a contact less IC module provided in a wristwatch device having a communication function. A timepiece control unit of a timepiece module transmits a confirmation command for the data, such as the credit balance, to a contact less IC module every determination cycle period TSP, and receives the data stored in the contact less IC module. When the value of the stored data (for example, the amount of balance) becomes smaller than a predetermined value, the timepiece control unit causes a second hand to perform an irregular movement noticeably different from the regular timing movement. Accordingly, the user is able to easily identify the data content (for example, insufficient balance).

This patent describes a wristwatch with a wide variety of functions that requires an external transceiver device to communicate data such as the credit balance. It has not been designed to have a LED screen for displaying different ornamental features or to function primarily as a wristwatch as does the graphic display programmable wristwatch.

None of these previous efforts, however, provides the benefits attendant with the graphic display programmable wristwatch. The present design achieves its intended purposes, objects and advantages over the prior art devices through a new, useful and unobvious combination of method steps and component elements.

In this respect, before explaining at least one embodiment of the graphic display programmable wristwatch in detail, it is to be understood that the design is not limited in its application to the details of construction and to the arrangement, of the components set forth in the following description or illustrated in the drawings. The graphic display programmable wristwatch is capable of other embodiments and of being practiced and carried out in various ways. In addition, it is to be understood that the phraseology and terminology employed herein are for the purpose of description and should not be regarded as limiting. As such, those skilled in the art will appreciate that the conception, upon which this disclosure is based, may readily be utilized as a basis for designing of other structures, methods and systems for carrying out the several purposes of the present design. It is important, therefore, that the claims be regarded as including such equivalent construction insofar as they do not depart from the spirit and scope of the present application.

### SUMMARY OF THE INVENTION

The principal advantage of the graphic display programmable wristwatch is to add a new and unique device to the area of wristwatches.

Another advantage is that a graphic display programmable wristwatch will feature an LCD or LED screen that will serve as the covering and the “face” of the wristwatch.

Another advantage is the preferred embodiment of the graphic display programmable wristwatch will maintain the round shape of a conventional wristwatch with the alternate embodiment of the graphic display watch in a square or rectangular configuration.

Another advantage is the graphic display programmable wristwatch will have a time-keeping mechanism.

Another advantage is the time-keeping mechanism can be tied to a number of networks, including the atomic clock or various Internet providers, including the MSN network.

Another advantage is the graphic display programmable wristwatch will have a central processor for processing digital information into graphic images.

Another advantage is the graphic display programmable wristwatch will incorporate a USB and power input ports along with a wireless input for downloading images.

Another advantage is the graphic display programmable wristwatch would be able to sequence through a number of different images on the LCD or LED screen.

Another advantage is a user can simply download a variety of different conventional watch faces, digital displays, static images, or animated images onto the LCD or LED screen and change them as often as desired.

Another advantage the graphic display programmable wristwatch will have is a selection of different wristbands that will be easily attached and removed by a new and unique method.

Another advantage is that the graphic image programmable wristwatch would use an external power source to charge the battery while the user is sleeping, using either a power cord or an optional docking station.

Yet another advantage is the graphic display programmable wristwatch will have the capability of displaying the watch face in a variety of different languages, symbols, or images.

And still another advantage is the graphic display programmable wristwatch will have an alarm function.

These together with other advantages of the preferred and alternate embodiment of the graphic display programmable wristwatch, along with the various features of novelty, which characterize the design, are pointed out with particularity in the claims annexed to and forming a part of this disclosure. For a better understanding of the graphic display programmable wristwatch, its operating advantages and the specific objects attained by its uses, reference should be made to the accompanying drawings and descriptive matter in which there are illustrated preferred and alternate embodiments of the graphic display programmable wristwatch. There has thus been outlined, rather broadly, the more important features of the design in order that the detailed description thereof that follows may be better understood, and in order that the present contribution to the art may be better appreciated. There are additional features of the graphic display programmable wristwatch that will be described hereinafter and which will form the subject matter of the claims appended hereto.

The preferred embodiment of the graphic display programmable wristwatch will be in the conventional round shape with a rotatable outer casing with an opening that when rotated will expose the USB port and the power connection port.

The alternate embodiment of the graphic display programmable wristwatch will be in a square or rectangular configuration with a sliding plate that will expose the USB port and the power connection port.

The preferred embodiment and alternate embodiment of the graphic display programmable wristwatch will have several distinct and innovative elements: an LCD or LED screen for displaying graphic images, a USB and wireless input for downloading images, a time-keeping mechanism, a central processor for processing digital information into graphic images and a power input port. It will feature an LCD or LED display screen that would serve as the covering and the “face” of the wristwatch but not have any “hands of a clock,” although such an image could be downloaded. The graphic display programmable wristwatch would be less a mechanical device and more an electronic device. The graphic display programmable wristwatch would be able to download from a computer and to save numerous graphic images. When the memory is full, the user would be able to replace downloaded images with new images.

The preferred and alternate embodiment of the graphic image programmable wristwatch would use an external power source that could charge the battery while the user is sleeping, using either a power cord or an optional docking station. With either, the power cord or the docking station, it can serve as a night clock and an alarm clock on the user's bed stand.

Time-keeping could be tied to a number of networks, including the atomic clock or various Internet providers, including the MSN network. Users who prefer to read time in a conventional manner can simply push the “time” button and see an analog or digital display of the precise time. This button will display time in a conventional manner while the user is holding down the button. Alternatively, a user many simply download a conventional watch face or digital display onto the screen.

The preferred and alternate embodiment of the graphic display programmable wristwatch will have several advantages over traditional analog and digital wristwatches, including unlimited graphic image displays, control by the user over the graphic display of the wristwatch and flexibility in changing the graphic display. It will be interactive because of a central processing unit, memory, and downloadable graphic images through USB or wireless connections.

The preferred and alternate embodiment of the graphic display programmable wristwatch, however, will be an electronic device that will allow the display of an infinite number of static and animated graphic images, including numbers in varying languages, symbols, and images that can be used to tell time. The same device can be used in any country in the world just by adjusting the language in the computer generated images reducing the overall manufacturing costs.

The graphic display programmable wristwatch will allow a user to download virtually any imaginable graphic image onto the wristwatch from the computer. The graphic images can be used, instead of or in addition to numbers, to tell time. The graphic image programmable wristwatch provides a user with the processing elements of a computer in the form of an infinite variety of graphic images and displays. Users will be able to download any imaginable image or animation into their wristwatch. They can choose an image that portrays a classic style, a contemporary style, photos of friends/family/pets, or cartoon characters, superheroes, movie action heroes, video game characters, promotional images, sports team logos, corporate logos, etc. They can choose static or moving animated graphic images. They can mix, match, and sequence the images. They can enjoy a series of downloaded graphic images that come with the wristwatch as a basic package and they can easily expand or replace the default images with new ones. The graphic display programmable wristwatch will appeal to young children as an entry level interaction electronic device. It will also appeal to teenagers, young adults, and people of all ages who desire the freedom to choose the way that time is represented.

The preferred and alternate embodiment of the graphic display programmable wristwatch provides the advantage of vastly expanded color and display options that can be molded, instantly and easily, to fit the fashion of the wearer. Wristwatches can become flexible or adjustable fashion pieces that can be changed on a daily or hourly basis to complement the clothing, mood, or circumstances of the user. The graphic display programmable wristwatch will have the capacity to display multiple graphic images through memory storage and downloadable capacity. This will enable users to find graphic images that reflect multiple facets of their personality.

### BRIEF DESCRIPTION OF THE DRAWINGS

The accompanying drawings, which are incorporated in and form a part of this specification, illustrate embodiments of the graphic display programmable wristwatch and together with the description, serve to explain the principles of this application.

FIG. 1 depicts a perspective view of the preferred embodiment of a graphic display programmable wristwatch on an individuals' wrist.

FIG. 1A depicts a side view of the preferred embodiment of a graphic display programmable wristwatch having a curved display screen face.

FIG. 2 depicts of the preferred embodiment of a graphic display programmable wristwatch setting on a docking station cradle.

FIG. 3 depicts a front view of the preferred embodiment of the graphic display programmable wristwatch with a square image area on the LCD or LED screen.

FIG. 4 depicts a front view of the preferred embodiment of a graphic display programmable wristwatch with a circular LCD or LED screen.

FIG. 5 depicts a side view of the preferred embodiment of the graphic display programmable wristwatch with the wristband removed and the outer casing rotated to expose the USB and power connection ports.

FIG. 6 depicts a bottom view of the preferred embodiment of the graphic display programmable wristwatch illustrating the wristband slot and the battery compartment cover.

FIG. 7 depicts a side view of the preferred embodiment of the graphic display programmable wristwatch with the outer casing rotated to enclose the wristband while covering the USB and power connection ports.

FIG. 8 depicts a bottom view of the preferred embodiment of the graphic display programmable wristwatch with the outer casing rotated to enclose the wristband and cover the USB and power connection ports.

FIG. 9 depicts a side view of the preferred embodiment of the graphic display programmable wristwatch with the outer casing rotated enclosing the wristband.

FIG. 10 depicts a top view of the wristband.

FIG. 11 depicts a side view of a section of the wristband and the top and bottom retaining ribs.

FIG. 12A depicts a front view of the preferred embodiment of the graphic display programmable wristwatch with a static image display watch face.

FIG. 12B depicts a front view of the preferred embodiment of the graphic display programmable wristwatch with an animated display watch face.

FIG. 12C depicts a front view of the preferred embodiment of the graphic display programmable wristwatch with a conventional watch face.

FIG. 13 depicts a front view of the preferred embodiment of the graphic display programmable wristwatch with a watch face using Chinese/Japanese characters.

FIG. 14 depicts front view of the alternate embodiment of the graphic display programmable wristwatch in a square configuration.

FIG. 15 depicts a left side view of the alternate embodiment of the graphic display programmable wristwatch in a square configuration.

FIG. 16 depicts a bottom view of the alternate embodiment of the graphic display programmable wristwatch in a square configuration with the sliding cover plate covering the outer casing opening.

FIG. 17 depicts a bottom view of the alternate embodiment of the graphic display programmable wristwatch in a square configuration, having a curved face, with the sliding cover plate open exposing the outer casing opening along with the USB port and the power connection port.

FIG. 18 depicts a packaging container with six different wristbands, a docking station cradle and a wristwatch body.

FIG. 19 depicts a schematic diagram of the internal and external components involved with the preferred and alternate embodiment of the graphic display programmable wristwatch.

### DETAILED DESCRIPTION OF THE PREFERRED EMBODIMENTS

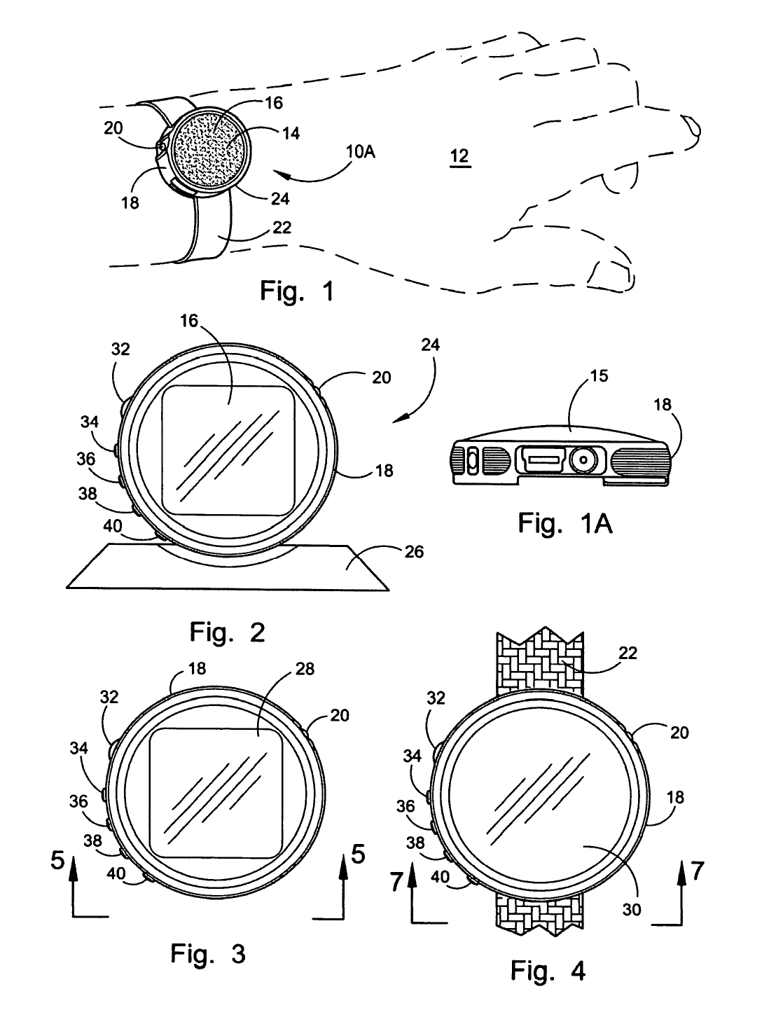

Referring now to the drawings, wherein similar parts of the preferred and alternate embodiment of the graphic display programmable wristwatch 10A and 10B are identified by like reference numerals, there is seen in FIG. 1a perspective view of a graphic display programmable wristwatch 10A on an individual's wrist 12 appearing the size and shape of a conventional wristwatch. The face 14 will consist of a LCD or LED screen 16 in a flat or curved configuration. Around the perimeter will be a rotateable outer casing 18 incorporating a spring loaded release button 20. The graphic display programmable wristwatch 10A will attach to a wristband 22 in a unique manner where by rotating the rotatable outer casing 18, the watch body 24 can be securely attached or readily removed from the wristband 22.

FIG. 1A depicts a side view of the preferred embodiment of a graphic display programmable wristwatch having a curved display screen face 15.

FIG. 2 depicts a graphic display programmable wristwatch 10A setting on a docking station cradle 26. The LCD or LED screen 16 is illustrated displaying a square configuration 28, but it must be understood that a wide variety of computer generated configurations are available including an LCD or LED in a circular, square or rectangular configuration 30 shown in FIG. 3. On the left side of the rotatable outer casing 18 are illustrated the: wireless sensor port 32, the button to display time in numbers 34, the button to freeze the image 36, the button to turn off and on the image 38 and the button to scroll through the images 40. On the right side of the rotatable outer casing 18 is shown the spring loaded release button 20.

FIG. 3 depicts a front view of a graphic display programmable wristwatch 10A with the LCD or LED square configuration 28 on the screen while FIG. 4 depicts a front view of a graphic display programmable wristwatch with a LCD or LED circular configuration 30 on the screen.

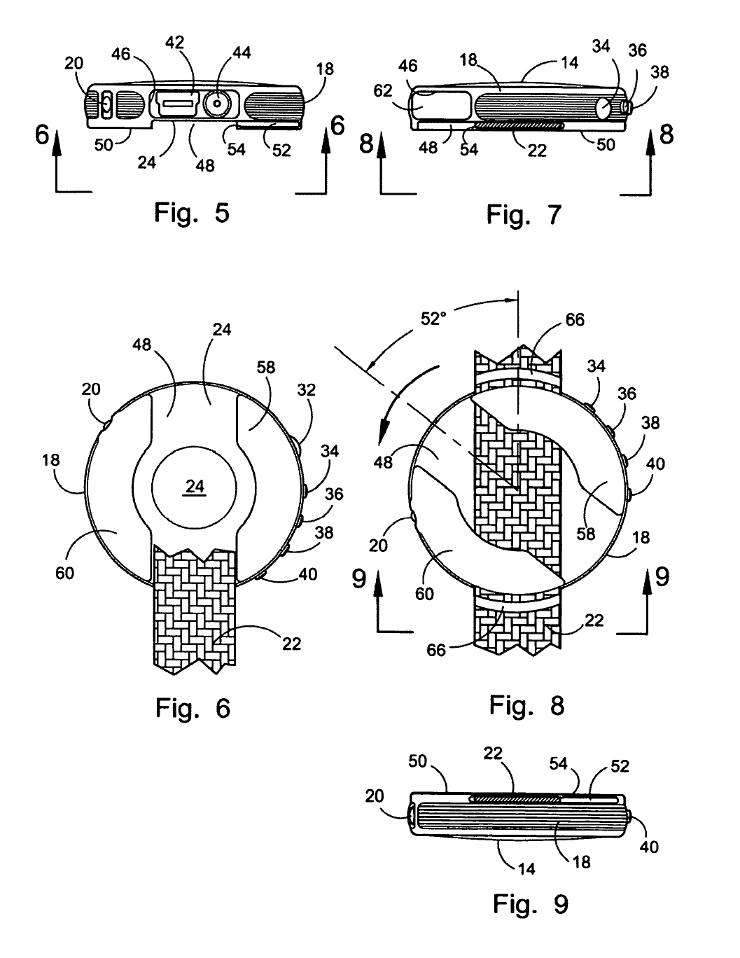

FIG. 5 depicts a side view of the graphic display programmable wristwatch 10A with the wristband 22 removed and the rotatable outer casing 18 rotated to expose the USB port 42 and power connection port 44 through the outer casing opening 46. The wristband slot 48 is exposed on the bottom surface 50 of the watch body 24. In this view, by rotating the rotatable outer casing 18 to this position, the wristband locking cavity 52 is moved to the right. The bulge 54 helps to retain the wristband 22 within the locking cavity 52 when the rotatable outer housing 18 is repositioned.

FIG. 6 depicts a bottom view of the graphic display programmable wristwatch 10A illustrating the wristband slot 48 and the battery compartment cover 56. With the graphic display programmable wristwatch 10A in this configuration the wristband slot 48 is parallel to the wristband 22 with the right side locking plate 58 and the left side locking plate 60 on either side of the wristband 22 making it easily removable.

FIG. 7 depicts a side view of the graphic display programmable wristwatch 10A with the rotatable outer casing 18 rotated fifty two degrees to enclose the wristband 22 within the wristband locking cavity 52 and cover the USB port 42 and power connection port 44. The rotation of the rotatable outer casing 18 is accomplished by the means of pressing the spring loaded release button 20 and rotating the rotatable outer casing 18. Also with the rotatable outer casing 18 in this position the outer casing opening 46 is over a solid body section 62 of the watch body 24.

FIG. 8 depicts a bottom view of the graphic display programmable wristwatch 10A with the rotatable outer casing 18 rotated fifty two degrees to enclose the wristband 22 and cover the USB port 42 and power connection port 44. This view illustrates how with the wristband slot 48 rotated fifty-two degrees; the right hand locking plate 58 and left hand locking plate 60 entrap the wristband 22 within the wristband locking cavity 52. A set of two top retaining ribs 64 and set of two bottom retaining ribs 66 are located on the wristband 22 to keep the graphic display programmable wristwatch 10 from sliding from side to side.

FIG. 9 depicts a side view of the graphic display programmable wristwatch 10A with the outer rotatable casing 18 rotated enclosing the wristband 22 within the wristband locking cavity 52. The bulges 54 on the right side locking plate 58 and left side locking plate 60 aids to position the wristband 22 and relieve the pressure on the spring loaded release button 20.

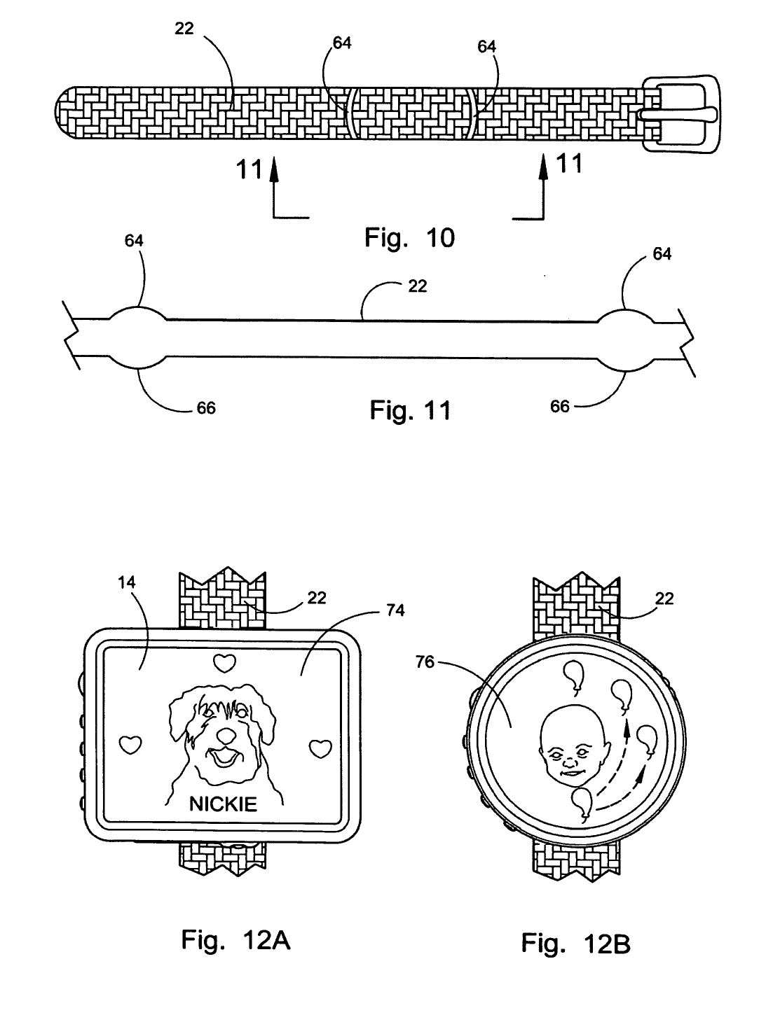

FIG. 10 depicts a top view of the wristband 22 illustrating the position of the two top retaining ribs 64. FIG. 11 depicts a side view of a section of the wristband 22 and the two top retaining ribs 64 and the two bottom retaining ribs 66.

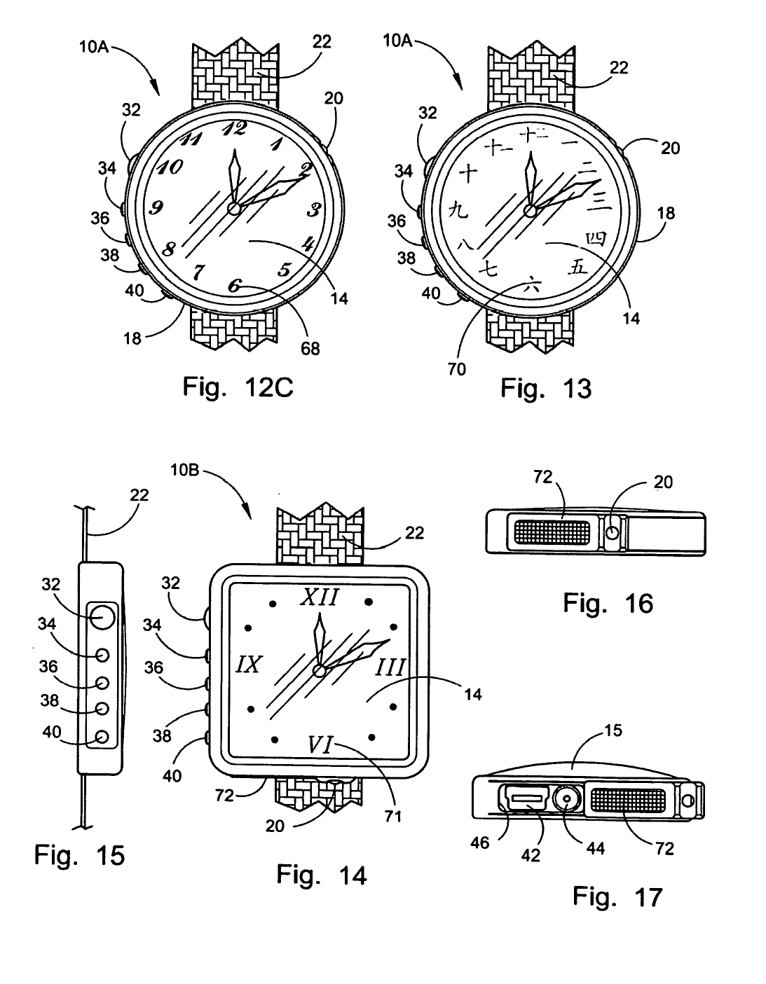

FIG. 12A depicts a front view of the preferred embodiment of the graphic display programmable wristwatch 10A with a static image display face 74. Here a photo of the pet dog is flanked by hearts at the 12, 3 and 9 position, with the pet's name in the 6 position. FIG. 12B depicts a front view of the preferred embodiment of the graphic display programmable wristwatch 10A with an animated image display face 76. Here a baby picture is flanked by balloons that appear and travel on the watch face, in the direction of the arrows shown, per unit of time passed, enabling the user to tell time in a uniquely fun fashion. Every static and animated image is capable of being customized to the user's unique specifications.

FIG. 12C depicts a front view of the preferred embodiment of the graphic display programmable wristwatch 10A with a conventionally numbered watch face 68. FIG. 13 depicts a front view of the graphic display programmable wristwatch 10A with a watch face using Chinese/Japanese characters 70.

FIG. 14 depicts an alternate embodiment of the graphic display programmable wristwatch 10B in a square configuration with the watch face 14 using Roman numerals 71. On the left side is illustrated the; wireless sensor port 32, the button to display time in numbers 34, the button to freeze the image 36, the button to turn off and on the image 38 and the button to scroll through the images 40. On the bottom will be a sliding cover plate 72 that when slid to the right will expose the USB port 42 and power connection port 44 by the means of the outer case opening 46. FIG. 15 depicts a left side view of the alternate embodiment of the graphic display programmable wristwatch 10B in a square configuration.

FIG. 16 depicts a bottom view of the alternate embodiment of the graphic display programmable wristwatch 10B in a square configuration with the sliding cover plate 72 covering the USB port 42 and the power connection port 44. FIG. 17 depicts a bottom view of the alternate embodiment of the graphic display programmable wristwatch 10B in a square configuration with the sliding cover plate 72 open exposing the outer casing opening 46 along with the USB port 42 and the power connection port 44. This embodiment also illustrates the curved display face 15.

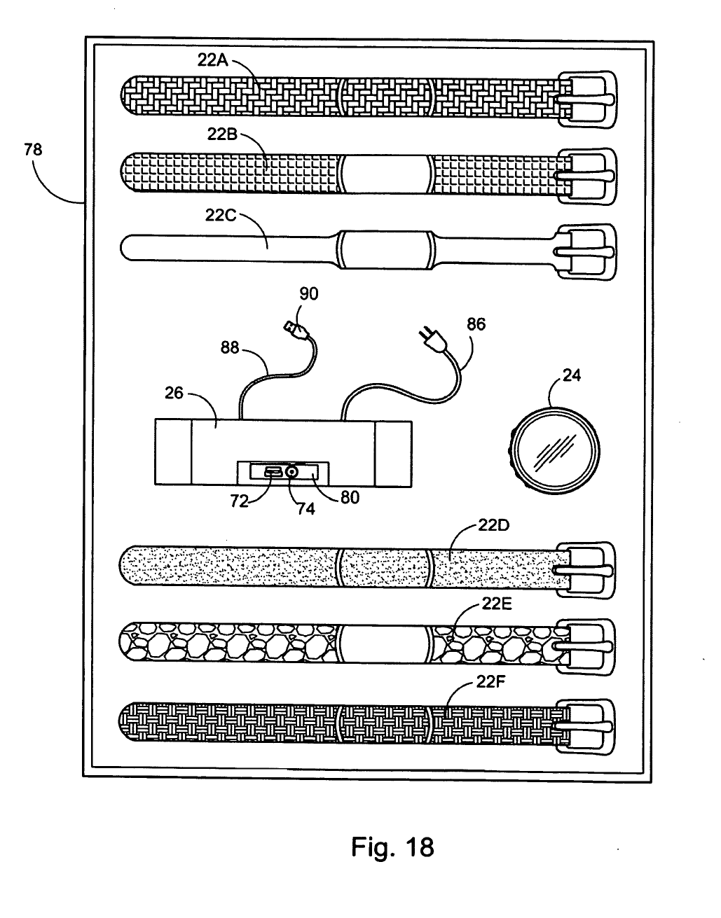

FIG. 18 depicts a packaging container 78 with six different wristbands 22A, 22B, 22C, 22D, 22E and 22F, a docking station 26 and a watch body 24. The docking station 26 is illustrated having a receiver area 80 where the watch body 24 will be inserted over the USB male plug 82 and the male power connector 84. A power cord 86 and a computer connection cord 88 equipped with a USB connector 90 are incorporated into the docking station 26. It must be understood that a conventional power converter can be used as a power supply remaining within the scope of this application.

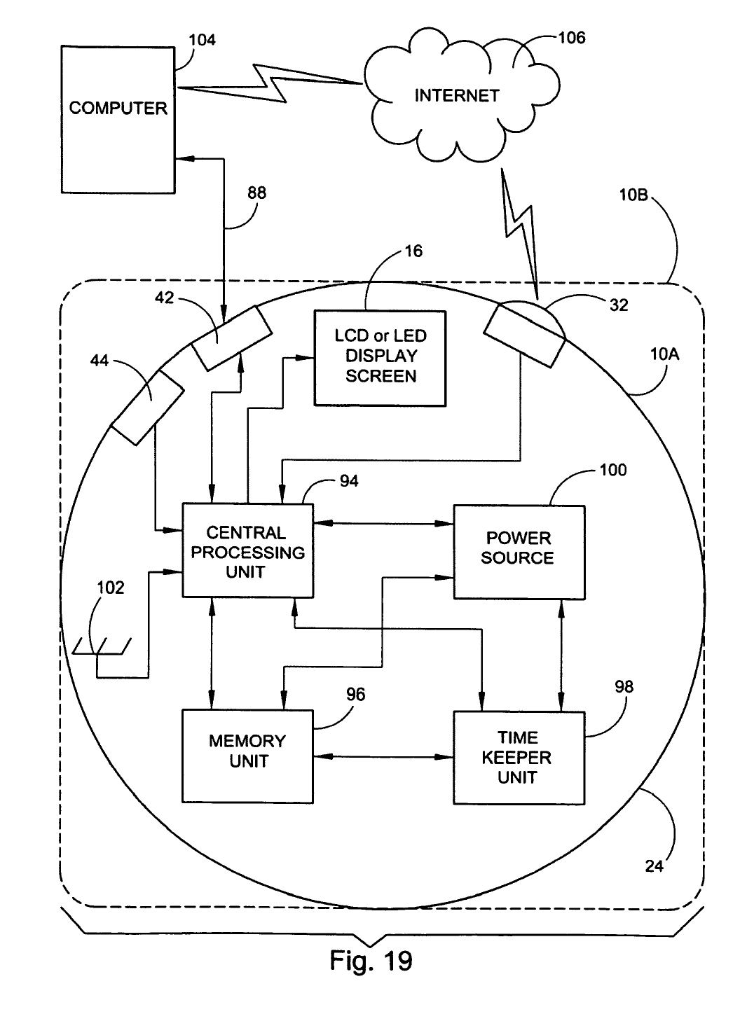

FIG. 19 depicts a schematic diagram of the internal and external components involved with the graphic display programmable wristwatch 10A and 10B. The watch body 24 is illustrated with the USB port 42 interconnected to the central processing unit 94. The central processing unit 94 is interconnected with the memory unit 96, the time keeper unit 98 and the power source 100. The central processing unit 94 will have an antenna input 102, along with an output to the LCD or LED display screen 16. Information will also be accessible from the wireless sensor port 32. There will be additional interconnections made between the memory unit 96, time keeper unit 98 and the power source 100. The USB port will be able to have a direct connection to a computer 104 by means of the computer connection cord 88 while the wireless sensor port 32 will access the Internet 106 directly. In this way, a user can interactively participate in the design and appearance of their time-piece by incorporating a processor, memory chip, and LED or LCD screen into the wristwatch. Graphic images can be downloaded from a computer, software CD, the Internet, flash drive or other source.

The preferred and alternate embodiment of the graphic display programmable wristwatch 10A and 10B shown in the drawings and described in detail herein disclose arrangements of elements of particular construction and configuration for illustrating preferred embodiments of structure and method of operation of the present application. It is to be understood, however, that elements of different construction and configuration and other arrangements thereof, other than those illustrated and described may be employed for providing the preferred and alternate embodiment of the graphic display programmable wristwatch 10A and 10B in accordance with the spirit of this disclosure. Such changes, alternations and modifications as would occur to those skilled in the art are considered to be within the scope of this application, as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the graphic display programmable wristwatch of this application which is measured by the claims, nor is it intended to be limiting as to the scope of the application in any way.

I claim:

1. A graphic display programmable wristwatch comprising:
(a) a wristwatch housing having an exterior surface including one or more control buttons and one or more communications ports on said exterior surface;
(b) a central processing unit, a memory unit, a power source and a time-keeping unit, all located within said wristwatch housing;
(c) an electronic display screen; and
(d) a software program run on said central processing unit, capable of controlling communications, memory, time-keeping and power, into and out of said wristwatch housing;
whereby said central processing unit can communicate with a conventional computer or network of computers through said communications ports to receive and store one or more display images in said memory unit and thereby display said display images as the user desires.

2. The graphic display programmable wristwatch according to claim 1, wherein said electronic display screen is an LCD screen.

3. The graphic display programmable wristwatch according to claim 1, wherein said electronic display screen is an LED screen.

4. The graphic display programmable wristwatch according to claim 1, wherein said one or more display images are static images.

5. The graphic display programmable wristwatch according to claim 1, wherein said one or more display images are animated images.

6. The graphic display programmable wristwatch according to claim 1, wherein said one or more display images are digital time-keeping images.

7. The graphic display programmable wristwatch according to claim 1, wherein said one or more display images are analog time-keeping images.

8. The graphic display programmable wristwatch according to claim 1, wherein said one or more communications ports enable hard wired communications between the graphic display programmable wristwatch and a conventional computer or network of computers.

9. The graphic display programmable wristwatch according to claim 1, wherein said one or more communications ports enable wireless communications between the graphic display programmable wristwatch and a conventional computer or network of computers.

10. The graphic display programmable wristwatch according to claim 9, wherein said wireless communications is via a conventional antenna.

11. The graphic display programmable wristwatch according to claim 9, wherein said wireless communications is via a conventional infrared computer port.

12. The graphic display programmable wristwatch according to claim 1, wherein said electronic display screen is round, square, or rectangular in shape.

13. The graphic display programmable wristwatch according to claim 12, wherein said electronic display screen is flat or curved.

14. The graphic display programmable wristwatch according to claim 1, wherein said wristwatch housing is removeably attachable to a wristwatch band.

15. The graphic display programmable wristwatch according to claim 14, wherein said wristwatch housing is removeably attachable to a wristwatch band including a one piece wristwatch band having one or more retaining ribs for securing said wristwatch housing.

16. The graphic display programmable wristwatch according to claim 1, wherein said wristwatch housing includes an integral protective cover for covering and protecting said communications ports.

17. The graphic display programmable wristwatch according to claim 1, wherein said wristwatch housing is sold in a display package including one or more wristwatch housings and one or more wristwatch bands.

18. The graphic display programmable wristwatch according to claim 1, wherein said wristwatch housing is sold including a cradle for storing the wristwatch housing, recharging said power source, and enabling hard wired communications with a conventional computer or network of computers.

19. A method for making a graphic display programmable wristwatch comprising the steps of:
(a) providing a wristwatch housing having an exterior surface including one or more control buttons and one or more communications ports on said exterior surface;
(b) providing a central processing unit, a memory unit, a power source and a time-keeping unit, all located within said wristwatch housing;
(c) providing an electronic display screen;
(d) providing a software program run on said central processing unit, capable of controlling communications, memory, time-keeping and power, into and out of said wristwatch housing;
(e) communicating between said central processing unit and a conventional computer or network of computers through said communications ports;
(f) receiving and storing one or more display images in said memory unit; and
(g) displaying said one or more display images as the user desires.

20. The method for making a graphic display programmable wristwatch according to claim 19, wherein said step of providing an electronic display screen includes the step of providing an LCD electronic display screen.

21. The method for making a graphic display programmable wristwatch according to claim 19, wherein said step of providing an electronic display screen includes the step of providing an LED electronic display screen.

22. The method for making a graphic display programmable wristwatch according to claim 19, wherein said steps of receiving, storing and displaying said one or more display images includes receiving, storing and displaying static images.

23. The method for making a graphic display programmable wristwatch according to claim 19, wherein said steps of receiving, storing and displaying said one or more display images includes receiving, storing and displaying animated images.

24. The method for making a graphic display programmable wristwatch according to claim 19, wherein said steps of receiving, storing and displaying said one or more display images includes receiving, storing and displaying digital time-keeping images.

25. The method for making a graphic display programmable wristwatch according to claim 19, wherein said steps of receiving, storing and displaying said one or more display images includes receiving, storing and displaying analog time-keeping images.

26. The method for making a graphic display programmable wristwatch according to claim 19, wherein said step of providing one or more communications ports includes the step of providing one or more communications ports which enable hard wired communications between the graphic display programmable wristwatch and a conventional computer or network of computers.

27. The method for making a graphic display programmable wristwatch according to claim 19, wherein said step of providing one or more communications ports includes the step of providing one or more communications ports which enable wireless communications between the graphic display programmable wristwatch and a conventional computer or network of computers.

28. The method for making a graphic display programmable wristwatch according to claim 27, wherein said step of providing one or more communications ports which enable wireless communications between the graphic display programmable wristwatch and a conventional computer or network of computers, includes providing a conventional antenna.

29. The method for making a graphic display programmable wristwatch according to claim 27, wherein said step of providing one or more communications ports which enable wireless communications between the graphic display programmable wristwatch and a conventional computer or network of computers, includes providing a conventional infrared computer port.

30. The method for making a graphic display programmable wristwatch according to claim 19, wherein said step of providing an electronic display screen includes providing a round, square or rectangular shaped electronic display screen.

31. The method for making a graphic display programmable wristwatch according to claim 30, wherein said step of providing a round, square or rectangular shaped electronic display screen, further includes providing an electronic display screen that is curved.

32. The method for making a graphic display programmable wristwatch according to claim 19, wherein said step of providing a wristwatch housing includes the step of providing a wristwatch housing which is removeably attachable to a wristwatch band.

33. The method for making a graphic display programmable wristwatch according to claim 32, wherein said step of providing a wristwatch housing which is removeably attachable to a wristwatch band, further includes providing a wristwatch housing which is removeably attachable to a one piece wristwatch band having one or more retaining ribs for securing said wristwatch housing.

34. The method for making a graphic display programmable wristwatch according to claim 19, wherein said step of providing a wristwatch housing includes the step of providing a wristwatch housing including an integral protective cover for covering and protecting said communications ports.

35. The method for making a graphic display programmable wristwatch according to claim 19, wherein said step of providing a wristwatch housing includes the step of providing a wristwatch housing sold in a package including one or more wristwatch housings and one or more wristwatch bands.

36. The method for making a graphic display programmable wristwatch according to claim 19, wherein said step of providing a wristwatch housing includes the step of providing a wristwatch housing sold in a package including a cradle for storing the wristwatch housing, recharging said power source, and enabling hard wired communications with a conventional computer or network of computers.
